(19) United States
(12) Patent Application Publication
(10) Pub. No.: US 2025/0342330 A1
(43) Pub. Date: Nov. 6, 2025

(54) OPTICAL INFORMATION READING TERMINAL AND A DATA AGGREGATION SYSTEM

(71) Applicant: KEYENCE CORPORATION, Osaka-shi (JP)

(72) Inventors: Takuki Nakagawa, Osaka-shi (JP); Kazumasa Satake, Osaka-shi (JP); Toru Miyawaki, Osaka-shi (JP)

(73) Assignee: KEYENCE CORPORATION, Osaka-shi (JP)

(21) Appl. No.: 19/181,732

(22) Filed: Apr. 17, 2025

(30) Foreign Application Priority Data
May 1, 2024 (JP) 2024-074156

(51) Int. Cl. G06K 7/10; G06F 21/31; G06Q 10/0631

(52) U.S. Cl. CPC G06K 7/1093; G06F 21/31; G06K 7/10861; G06Q 10/063114

(57) ABSTRACT

The optical information reading terminal includes an imaging unit, a reading unit, a storage unit that stores a work selection application and identification information, a display unit that displays display information, a control unit, and a communication unit. The imaging unit captures an image of a symbol to generate an input image. The reading unit reads symbol information based on the input image. The work selection application allows a user to select an execution work item. The identification information identifies the optical information reading terminal or the user. The communication unit communicates with an external information processing device. The control unit transmits terminal data in which the symbol information and the execution work item are associated with the identification information via the communication unit.

### CROSS-REFERENCE TO RELATED APPLICATIONS

The present application claims foreign priority based on Japanese Patent Application No. 2024-074156, filed May 1, 2024, the contents of which are incorporated herein by reference.

### BACKGROUND OF THE INVENTION

### 1. Technical Field

This disclosure relates to an optical information reading terminal and a data aggregation system.

### 2. Description of the Related Art

JP 2022-055006 A discloses an optical information reading device and an optical information reading method.

The optical information reading device described in JP 2022-055006 A captures an image of a symbol that is the reading target, reads the information of that symbol, and outputs the read data.

In facilities (such as logistics warehouses) where such optical information reading devices are used, it is common for multiple users to perform tasks within the facility. Additionally, multiple optical information reading devices are prepared, and different users use separate optical information reading devices to perform their tasks.

There are multiple types of work performed by users (for example, shipping operations, warehousing operations, etc.), and the same user may perform different types of work depending on the time period. Also, different users may use the same optical information reading device depending on the time period, or the same user may use different optical information reading devices depending on the time period.

However, conventional optical information reading devices merely read information of captured symbols and output read data, and did not output information not directly related to the symbol information, such as information about the type (item) of work performed by the user, unique information for each optical information reading device, or information about the user using the device.

Therefore, in facilities where conventional optical information reading devices were used, it was difficult to investigate information not directly related to the symbol information, such as the types of work performed by users, unique information of the optical information reading device, and information related to users, from the output read data.

### SUMMARY OF THE INVENTION

In view of the above problem, this disclosure aims to provide an optical information reading terminal and a data aggregation system that make it easy to investigate information related to work performed using the optical information reading terminal based on data output from the optical information reading terminal.

According to one aspect of this disclosure, an optical information reading terminal captures an image of a symbol to be read and reads symbol information represented by the symbol. The optical information reading terminal includes an imaging unit, a reading unit, a storage unit, a display unit, a communication unit, and a control unit. The imaging unit captures an image of the symbol and generates an input image. The reading unit reads symbol information based on the input image. The storage unit stores a work selection application for selecting an execution work item from multiple work items to be executed by a user who performs work using the symbol information read by the reading unit, and identification information that identifies the optical information reading terminal or the user using the optical information reading terminal. The display unit displays display information including a screen of the work selection application for selecting the execution work item. The communication unit communicates with an external information processing device. The control unit transmits terminal data associated with the identification information related to the optical information reading terminal to the information processing device via the communication unit, where the terminal data includes the symbol information read by the reading unit and the execution work item selected through the work selection application.

According to another aspect of this disclosure, a data aggregation system includes one or more of the aforementioned optical information reading terminals, an information processing device, and a display device. The information processing device communicates with the optical information reading terminal. The display device performs display based on signals received from the information processing device. The information processing device includes a second communication unit that receives terminal data from one or more optical information reading terminals, an aggregation processing unit that generates aggregation results related to work performed by users based on the terminal data, and a display processing unit that causes the display device to display the aggregation results.

According to the optical information reading terminal and data aggregation system of this disclosure, it becomes easy to investigate information related to work performed using the optical information reading terminal based on data output from the optical information reading terminal.

### BRIEF DESCRIPTION OF THE DRAWINGS

FIG. 1 is a schematic diagram showing a data aggregation system including an optical information reading terminal.

FIG. 2 is a schematic block diagram showing the configuration of the optical information reading terminal.

FIG. 3 is a schematic block diagram showing the configuration of the information processing device.

FIG. 4 is a flowchart showing the operation flow of the optical information reading terminal.

FIG. 5 is a flowchart showing the operation flow of the information processing device.

FIG. 6 is a diagram showing an example of identification information.

FIG. 7 is a diagram showing an example of terminal data.

FIG. 8 is a diagram showing another example of terminal data.

FIG. 9 is a diagram showing an example of a login screen.

FIG. 10 is a diagram showing an example of a work selection application screen.

FIG. 11 is a diagram showing an example of an aggregation result display screen.

FIG. 12 is a diagram showing another example of an aggregation result display screen.

FIG. 13 is a diagram showing an example of an application creation screen.

### DETAILED DESCRIPTION

The embodiments of this disclosure will be explained below with reference to the drawings. In the figures, the same or corresponding parts are denoted by the same reference numerals, and repetitive explanations are omitted. In the following description, terms indicating position or direction such as “up”, “down”, “left”, and “right” may be used. These terms are used for convenience to facilitate understanding of the embodiments and, unless explicitly stated otherwise, are not related to the actual direction when implemented.

The following description will be given of a data aggregation system 100 including an optical information reading terminal 10 according to an embodiment of this disclosure, with reference to the drawings.

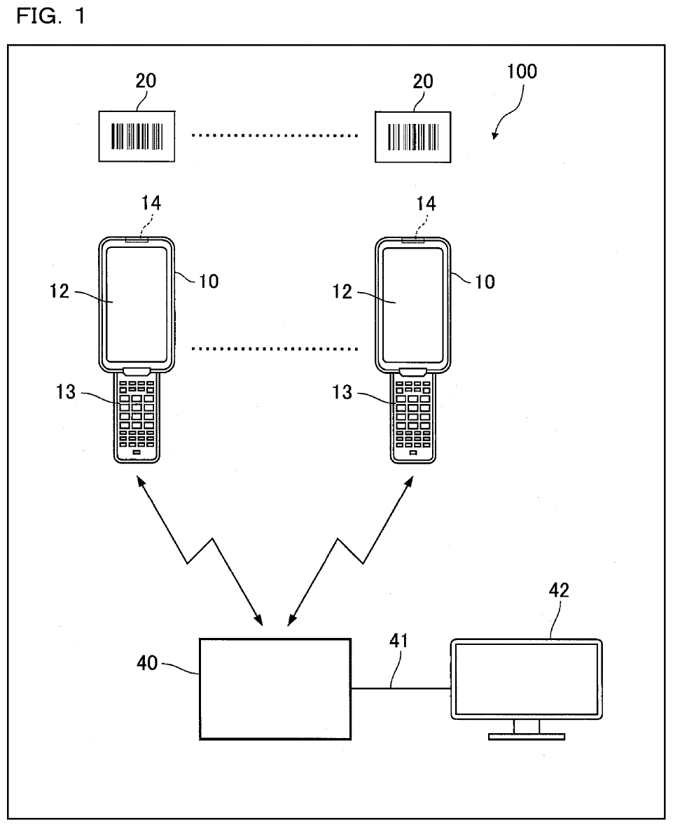

First, referring to FIG. 1, the work performed in the data aggregation system 100 will be explained. FIG. 1 is a schematic diagram showing the data aggregation system 100 including the optical information reading terminal 10.

The data aggregation system 100 includes one or more optical information reading terminals 10, an information processing device 40, and a display device 42. The optical information reading terminal 10 captures an image of a symbol 20 that is the reading target and reads the symbol information represented by the symbol 20. The information processing device 40 communicates with the optical information reading terminal 10. The display device 42 displays based on signals received from the information processing device 40.

The optical information reading terminal 10 is a device that can be held and carried in the hand by a user (not shown) who performs work using the symbol information represented by the symbol 20 in the data aggregation system 100, and is sometimes called a handy terminal. The optical information reading terminal 10 includes a display unit 12, an input unit 13, and an imaging unit 14. The optical information reading terminal 10 is covered with a housing, and the display unit 12 and the input unit 13 are provided on the top surface of the housing. The imaging unit 14 is provided at the tip of the housing.

The display unit 12 displays various information to the user. The display unit 12 is, for example, a liquid crystal display (LCD) or an organic EL display. The input unit 13 accepts various inputs to the optical information reading terminal 10. The input unit 13 includes multiple operation keys such as a numeric keypad, power key, function key, and trigger key. The display unit 12 may also be a touch panel display that serves as the input unit 13.

The imaging unit 14 captures the symbol 20 to generate an input image. The imaging unit 14 is, for example, a camera unit that includes an image sensor such as a CMOS or CCD that converts light into electrical signals, and optical elements (such as lenses) that collect reflected light from the symbol 20 and direct it onto the image sensor.

In addition, the optical information reading terminal 10 may include a power supply unit and an illumination unit, which are not illustrated. The power supply unit supplies driving power to the optical information reading terminal 10. The illumination unit irradiates aiming light to assist in capturing the symbol 20 by the imaging unit 14.

Symbol 20 represents information in an optically readable form, and for example, barcodes and two-dimensional codes are used as Symbol 20. Symbol 20 can be anything that is optically readable, for example, it can be a character string that directly represents the content of the information. Symbol 20 is displayed on the surface of an item that is the subject of work in the data aggregation system 100. Symbol 20 is, for example, directly printed on the surface of a commercial product, or a label printed with Symbol 20 is attached to the surface of the item. One specific example of the content included in the information represented by the symbol (symbol information) is the product name of the commercial product on which Symbol 20 is displayed.

The information processing device 40 is a device that manages the work performed within the data aggregation system 100. The information processing device 40 communicates with the optical information reading terminal 10 through wireless communication or the like, and provides instructions to the user by transmitting data to the optical information reading terminal 10, or performs aggregation processing based on data received from the optical information reading terminal 10. The information processing device 40 is, for example, a computer that functions as a server device.

The information processing device 40 is connected to the display device 42 via a video cable 41 such as an HDMI (registered trademark) cable. The display device 42 is, for example, a liquid crystal display type monitor device. The display device 42 displays based on signals received from the information processing device 40 via the video cable 41.

In the data aggregation system 100, multiple users perform work using optical information reading terminals 10. There are multiple types (items) of work that users execute using symbol information, such as warehousing operations and shipping operations, and users capture images of symbols 20 attached to the work target items using the optical information reading terminal 10 according to the work they perform.

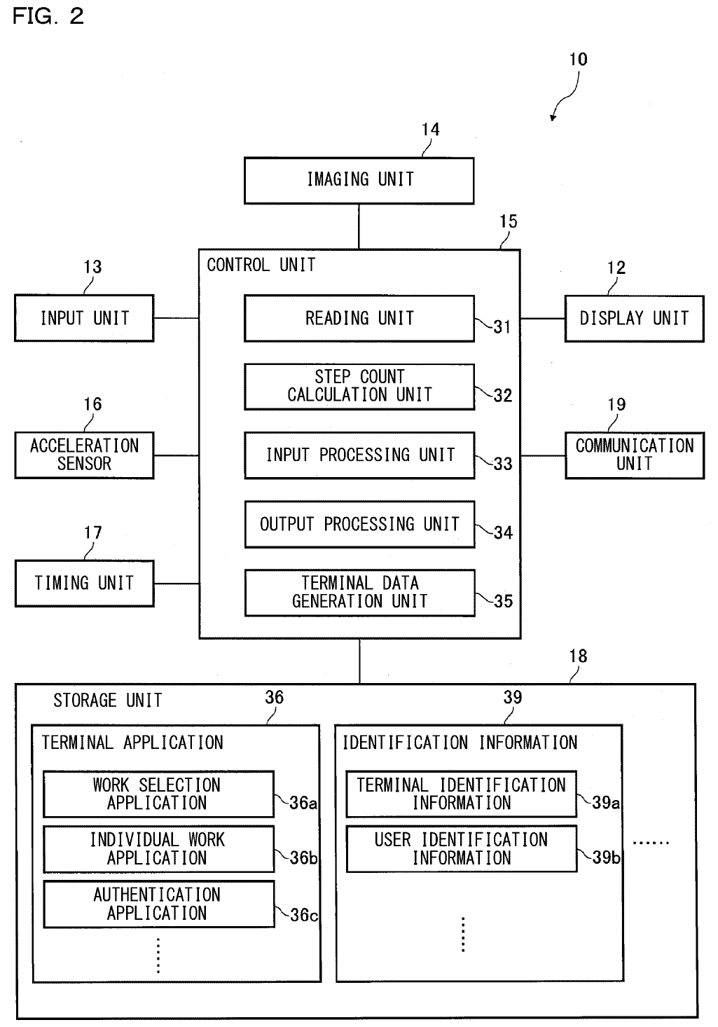

Next, referring to FIG. 2, the configuration of the optical information reading terminal 10 will be described. FIG. 2 is a schematic block diagram showing the configuration of the optical information reading terminal 10. The optical information reading terminal 10 in FIG. 2 includes a display unit 12, an input unit 13, an imaging unit 14, a control unit 15, an acceleration sensor 16, a timing unit 17, a storage unit 18, and a communication unit 19.

The control unit 15 also includes a reading unit 31, a step count calculation unit 32, an input processing unit 33, an output processing unit 34, and a terminal data generation unit 35. The storage unit 18 stores terminal applications 36 and identification information 39. The terminal applications 36 include a work selection application 36a, an individual work application 36b, an authentication application 36c, and others. The identification information 39 includes terminal identification information 39a, user identification information 39b, and others.

The control unit 15 is a unit including a processor such as a CPU. The control unit 15 realizes functions such as the reading unit 31, step count calculation unit 32, input processing unit 33, output processing unit 34, and terminal data generation unit 35 by reading and executing program data stored in the storage unit 18.

The acceleration sensor 16 is a sensor that detects the acceleration of the optical information reading terminal 10. The acceleration sensor 16 detects, for example, changes in the velocity of the optical information reading terminal 10 caused by the walking of a user carrying the optical information reading terminal 10.

The timing unit 17 is a unit that generates time information. The timing unit 17 has, for example, a timer unit, and generates time-related information such as the current time and the elapsed time since the optical information reading terminal 10 was started up.

The communication unit 19 is a communication interface unit for data communication between the optical information reading terminal 10 and other devices, and performs data communication, for example, by wireless communication (such as wireless LAN). The communication unit 19 of the optical information reading terminal 10 specifically communicates with the information processing device 40 of the data aggregation system 100. It should be noted that as long as data is communicated between the optical information reading terminal 10 and the information processing device 40 via the communication unit 19, the communication unit 19 does not necessarily need to communicate directly with the information processing device 40. For example, there may be a device (such as a router or gateway device) that relays communication between the optical information reading terminal 10 and the information processing device 40.

The storage unit 18 is a unit such as ROM that stores electronic data. The storage unit 18 stores terminal application 36, identification information 39, and so on. As mentioned earlier, the storage unit 18 also stores program data for realizing the functions of the control unit 15, but for convenience, various functions of the control unit 15 are illustrated as being included in the control unit 15 in FIG. 2.

The work selection application 36a included in the terminal application 36 is an application for selecting (having the user select) an execution work item to be executed by the user from among multiple work items.

The individual work application 36b is an application that assists users in performing work (such as warehousing operations, shipping operations, etc.) according to individual work items. There may be multiple individual work applications 36b corresponding to the number of types of work items, or a single individual work application 36b may be capable of assisting with multiple work items.

The authentication application 36c is an application for restricting the use of the optical information reading terminal 10 to specific users. The authentication application 36c identifies users, for example, by password authentication using a password predetermined by the user, biometric authentication (fingerprint authentication, face authentication, vein authentication, etc.) using the user's biometric information, or physical key authentication using a physical entity (such as an NFC card) carried by the user. Based on the authentication information presented by the user, the authentication application 36c identifies whether the user is a specific user (registered user) who has been pre-registered as a user allowed to use the optical information reading terminal 10. If the user is not a registered user, the application prohibits that user from using the optical information reading terminal 10. On the other hand, if the user is authenticated as a registered user, the authentication application 36c releases the usage restriction of the optical information reading terminal 10 for the authenticated user.

The terminal identification information 39a included in the identification information 39 is information unique to each individual optical information reading terminal 10 for individually identifying each of the multiple optical information reading terminals 10. For example, a serial number individually assigned to each optical information reading terminal 10 is used as the terminal identification information 39a.

The user identification information 39b is information unique to each individual user for individually identifying multiple users. For example, a serial number individually assigned to each user may be used as the serial number as the terminal identification information 39a. The user identification information 39b may also include authentication information for the user used in the authentication application 36c. For example, the user identification information 39b may include the user's authentication ID and authentication password.

The reading unit 31 of the control unit 15 reads symbol information represented by the symbol 20 based on the input image captured by the imaging unit 14 of the symbol 20. For example, the reading unit 31 reads the symbol information by decoding the information encoded in the symbol 20. When the symbol 20 is a character string, the reading unit 31 reads the symbol information by performing optical character recognition (OCR) of the character string. The symbol information includes at least one of, for example, the type of code read (e.g., the category such as barcode, two-dimensional code, etc.), the value of the code read (e.g., a numerical value assigned to a product name, etc.), and the character string read (e.g., a product name, etc.).

The step count calculation unit 32 calculates the number of steps taken by the user using the optical information reading terminal 10 while carrying it, based on the acceleration of the optical information reading terminal 10 detected by the acceleration sensor 16. For example, the step count calculation unit 32 determines that the user is walking when the detected acceleration changes according to the acceleration change pattern that occurs when the user walks, and calculates the number of steps according to the change pattern.

The input processing unit 33 performs signal processing related to input data representing input accepted by the input unit 13. For example, if the input unit 13 includes multiple operation keys, the input processing unit 33 transmits input data representing information such as which operation key was operated, in what order they were operated, and how the operation keys were operated, to other functions that require the input data. Additionally, when the authentication application 36c performs biometric authentication, the input unit 13 includes devices for reading biometric information such as a fingerprint reader, facial image capture device, and vein reader, and the input processing unit 33 also performs the reading of biometric information. Furthermore, when physical key authentication is performed, the input unit 13 includes devices (such as a card reader) for reading information from physical keys like NFC cards (near-field communication cards), and the input processing unit 33 also performs the reading of information stored in the physical keys.

The output processing unit 34 performs signal processing to output data processed within the control unit 15 as output data to the outside of the control unit 15. For example, the output processing unit 34 transmits display screen data generated by the terminal application 36 for display on the display unit 12 to the display unit 12. Additionally, the output processing unit 34 transmits terminal data generated by the terminal data generation unit 35, which will be described later, to the information processing device 40 shown in FIG. 1 via the communication unit 19. In other words, the control unit 15 transmits the terminal data generated by the terminal data generation unit 35 to the information processing device 40 via the communication unit 19 using the output processing unit 34.

The terminal data generation unit 35 generates terminal data in which the symbol information read by the reading unit 31 and the execution work item selected through the work selection application 36a are associated with the identification information 39 related to the optical information reading terminal 10 itself. The identification information 39 related to the optical information reading terminal 10 itself includes at least one of the terminal identification information 39a of the optical information reading terminal 10 to which the terminal data generation unit 35 belongs and the user identification information 39b of the user using the optical information reading terminal 10.

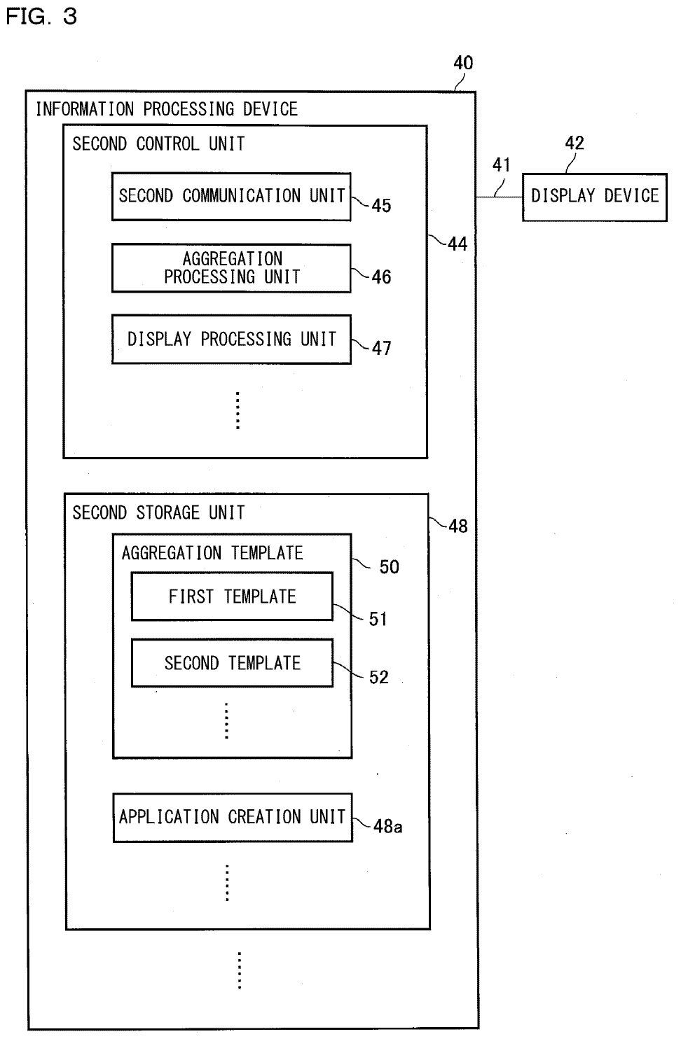

Next, referring to FIG. 3, the configuration of the information processing device 40 in FIG. 1 will be described. FIG. 3 is a schematic block diagram showing the configuration of the information processing device 40. The information processing device 40 includes a second control unit 44 and a second storage unit 48. The second control unit 44 is equipped with a processor such as a CPU, and by this processor calling and executing program data stored in the second storage unit 48, functions such as the second communication unit 45, aggregation processing unit 46, and display processing unit 47 are executed.

The second communication unit 45 receives terminal data from one or more optical information reading terminals 10. When the data aggregation system 100 includes multiple optical information reading terminals 10, the second communication unit 45 receives terminal data from multiple optical information reading terminals 10. As mentioned earlier, since identification information 39 is associated with the terminal data, the second communication unit 45 can distinguish, based on the identification information 39, which optical information reading terminal 10 sent the received terminal data, or which user sent it. The second communication unit 45 can also transmit data from the information processing device 40 to the optical information reading terminal 10. For example, data of the work selection application 36a generated by the application creation unit 48a, which will be described later, is transmitted from the information processing device 40 to the optical information reading terminal 10 via the second communication unit 45.

The aggregation processing unit 46 generates aggregation results related to the work performed by the user based on the terminal data received by the second communication unit 45. For example, the aggregation processing unit 46 summarizes the symbol information of the symbols 20 read within the data aggregation system 100 for each optical information reading terminal 10 that performed the reading or for each user who used the terminal, and then generates aggregation results combined with other data. The aggregation processing unit 46 may generate tabular data or graph format data as aggregation results. For example, the aggregation processing unit 46 should generate aggregation results using at least one of the following as aggregation criteria: the execution work item selected by the work selection application 36a, the symbol information read by the reading unit 31, the number of readings by the reading unit 31, and the identification information 39 related to the optical information reading terminal itself. The number of readings may be included in the terminal data generated by the terminal data generation unit 35, or it may be calculated by the aggregation processing unit 46 based on the terminal data. For example, the terminal data generation unit 35 should increase the number of readings included in the terminal data each time a reading is performed by the reading unit 31. Additionally, the aggregation processing unit 46 may, for example, organize various data sets (records) included in the terminal data by identification information (by user or by optical information reading terminal 10), and calculate the number of records corresponding to each user or each optical information reading terminal 10 as the number of readings.

The display processing unit 47 displays the aggregation result generated by the aggregation processing unit 46 on the display device 42. For example, the display processing unit 47 converts the data of the aggregation result into image data in a format that can be displayed on the display device 42, and transmits it to the display device 42.

The second storage unit 48 is a unit such as ROM that stores electronic data. The second storage unit 48 stores aggregation templates 50, program data of the application creation unit 48a, and so on. Although program data for realizing the functions of the information processing device 40 is also stored in the second storage unit 48 as mentioned above, for convenience, various functions of the information processing device 40 are illustrated as being included in the second control unit 44 in FIG. 3.

The aggregation template 50 includes multiple templates such as the first template 51, the second template 52, and so on. For each of the multiple templates, a predetermined aggregation criterion is associated. The aggregation criterion is data that indicates which data item among the multiple data items included in the terminal data should be focused on, and in what display format the aggregation results should be displayed. The aggregation template 50 specifies the display format when displaying the aggregation results on the display device 42, based on the aggregation criteria. For example, when the aggregation results are displayed in a graph format, it is preferable that the aggregation template 50 includes information indicating that the display format is a graph format, and information about the aggregation axes, such as which data item should be used for the horizontal axis and which data item should be used for the vertical axis in that graph. Also, when the display format is a table format, it is preferable that the aggregation template 50 includes information about which data items should be arranged in the row direction and column direction respectively.

The application creation unit 48a is program data that generates a work selection application 36a used in the optical information reading terminal 10 by accepting input of information related to multiple work items performed by a user. The work selection application 36a generated by the application creation unit 48a is transmitted to the optical information reading terminal 10 via the second communication unit 45.

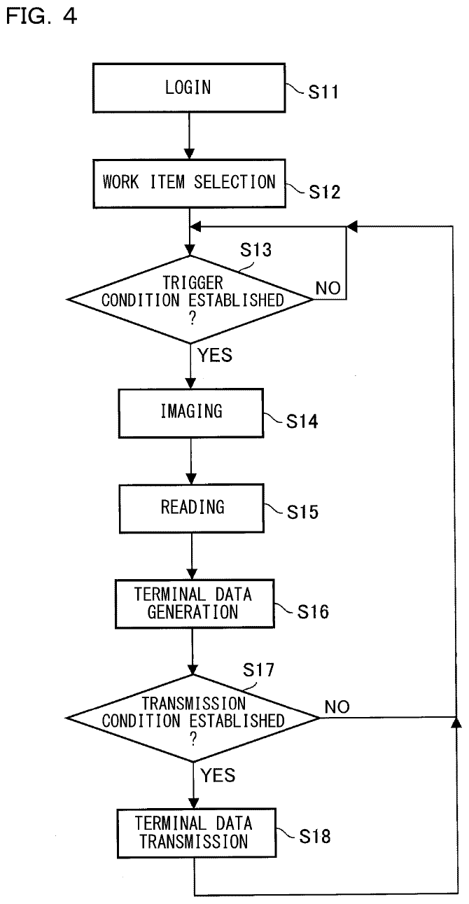

Next, referring to FIG. 4, the general flow of operation of the optical information reading terminal 10 will be explained. FIG. 4 is a flowchart showing the flow of operation of the optical information reading terminal 10. The optical information reading terminal 10 operates according to the terminal application 36 stored in the storage unit 18, and calls up individual applications such as the work selection application 36a as necessary.

When the optical information reading terminal 10 is started up, it first accepts the user's login at step S11. The startup of the optical information reading terminal 10 is performed, for example, when the user presses the power key provided as part of the input unit 13, and the optical information reading terminal 10 initializes (resets) the memory area at startup. The first program data to be loaded after initialization is for login acceptance, and while accepting the login, the display unit 12 of the optical information reading terminal 10 displays a login screen guiding the user through the login procedure.

In step S11, the user logs in by operating the input unit 13 following the guidance on the login screen displayed on the display unit 12 of the optical information reading terminal 10. During login, the user presents their authentication information to the optical information reading terminal 10.

When the user is a registered user who has been previously registered as a known user in the data aggregation system 100, the user presents their authentication information to the optical information reading terminal 10 (for example, enters their ID and password). During login, the authentication application 36c operates (the terminal application 36 calls the authentication application 36c), and the authentication application 36c confirms whether the presented authentication information matches the known authentication information registered in the data aggregation system 100.

For example, if known authentication information (registered authentication information) is stored in the storage unit 18 of the optical information reading terminal 10, the authentication application 36c confirms whether the presented authentication information matches any of the known authentication information stored. In cases where the authentication information is not stored in the storage unit 18 of the optical information reading terminal 10 but only in the information processing device 40, during the verification of authentication information, the optical information reading terminal 10 may transmit the input authentication information to the information processing device 40, and the verification with the registered authentication information stored in the information processing device 40 may be performed. It is preferable that the transmission and reception of authentication information be carried out in an encrypted state.

If the authentication information presented by the user matches the registered authentication information, the user is determined to be a registered user, and the user corresponding to that authentication information is set to a logged-in state. If the authentication information presented by the user does not match the registered authentication information, it is considered a login failure, and the authentication application 36c guides the user who failed to log in to present the authentication information again. Depending on the level of security required by the data aggregation system 100, the authentication application 36c may prohibit subsequent login operations for a user who has failed to log in several times by setting them as unable to log in.

On the other hand, when a user wishes to register as a new user in the data aggregation system 100, the authentication application 36c prompts the user to present unregistered authentication information. When asked for unregistered authentication information, the user presents, for example, an unregistered ID and password (or biometric information, physical key, etc.). If the presented authentication information does not match the registered authentication information, the authentication application 36c stores the presented authentication information as registered authentication information in the storage unit 18 and logs in the user who presented the authentication information. Depending on the level of security required by the data aggregation system 100, it may be configured so that registration of new users is only possible on the information processing device 40, and new users cannot be registered using the optical information reading terminal 10.

When the user's login is completed, the authentication application 36c releases the usage restriction of the optical information reading terminal 10 for the logged-in user (authenticated by the authentication application 36c). Hereafter (until logout), operations and work performed using the optical information reading terminal 10 used for login are treated as being performed by the user who presented the authentication information.

After the user's login is completed, the terminal application 36 proceeds to step S12 and calls up the work selection application 36a to have the user select an execution work item to be performed by the user from among multiple work items. The selection of the work item may be performed at the time of terminal data generation or when the transmission condition is met, which will be described later.

In step S12, for example, multiple work item options (such as warehousing operation, shipping operation, etc.) are displayed on the display unit 12, and the user uses the input unit 13 to select the work item they are about to execute (or, in cases where the work item selection is performed during terminal data generation or when the transmission condition is met, the work item they have already executed) from the options. For example, if the input unit 13 is a touch panel display integrated with the display unit 12, the user can select a work item by touching the options displayed on the display unit 12. If the input unit 13 is not integrated with the display unit 12, the user uses the input unit 13 to select options within the display unit 12. For instance, if the input unit 13 includes direction keys and a decision key, the user can move a cursor displayed on the display unit 12 using direction keys, and when the cursor aligns with the desired option, they operate the decision key to select the option.

Here, the work selection application 36a may further accept registration of shipper information related to the selected work item along with the selection of the work item. For example, in a warehousing operation, registration of which shipper the warehousing operation is performed for may be accepted. In registering shipper information, for example, options of information for multiple shippers may be displayed on the display unit 12, and the user should select the information of the shipper corresponding to the current work using the input unit 13 from among those options.

When the selection of work items is completed, the terminal application 36 calls up the individual work application 36b corresponding to the selected work item. The called-up individual work application 36b determines in step S13 whether a trigger condition that defines the timing to start capturing the symbol 20 is established. The trigger condition is a condition that defines whether or not the imaging unit 14 can capture the symbol 20, and for example, it is considered that the trigger condition is established when the user releases their hand from the trigger key (or trigger button displayed on the display unit 12) included in the input unit 13 after it has been pressed by the user. The trigger condition is set in various ways according to the work environment in the data aggregation system 100. For example, it may be considered that the trigger condition is established at the moment the trigger key is pressed. In addition to the operation of the trigger key, whether or not the imaging environment suitable for reading the symbol 20 is ready may also be included in the trigger condition. For example, since it may not be possible to read the symbol 20 in a dark room, the trigger condition may be set to be established only when the trigger key is operated when it is detected that sufficient illumination is hitting the symbol 20 to be read (for example, when the camera of the imaging unit 14 detects sufficient light).

If the trigger condition is not established (NO in step S13), the individual work application 36b waits until the trigger condition is established (repeats step S13). When the trigger condition is established (YES in step S13), the individual work application 36b proceeds to step S14 and performs imaging of the symbol 20 by the imaging unit 14.

Next, the individual work application 36b proceeds to step S15 and performs reading of symbol information from the input image obtained by imaging using the reading unit 31. If the symbol 20 displays encoded information such as a barcode or two-dimensional code, the reading unit 31 reads the symbol information by decoding the encoded information. If the symbol 20 is a character string, the reading unit 31 reads the symbol information by performing optical character recognition (OCR) of the character string. If the symbol information cannot be read due to reasons such as the symbol 20 being out of focus in the input image, it is advisable for the individual work application 36b to display on the display unit 12 that the symbol information could not be read, prompting the user to perform imaging again.

When symbol information is read, the individual work application 36b proceeds to step S16, where the terminal data generation unit 35 creates terminal data. The terminal data generation unit 35 generates terminal data in which the symbol information read by the reading unit 31 and the execution work item selected through the work selection application 36a are associated with the identification information 39 related to the optical information reading terminal 10 itself.

The identification information 39 related to the optical information reading terminal 10 itself includes at least one of the terminal identification information 39a assigned to the optical information reading terminal 10 itself that is generating the terminal data by the terminal data generation unit 35, and the user identification information 39b of the user who is executing (logged in) the work using the optical information reading terminal 10. The terminal data in which symbol information and execution work items are assigned to the identification information 39 is, for example, combination data (table) that includes the combination of symbol information, execution work item, and identification information 39 as a single set. Also, the terminal data may be, for example, generated separately as combination data of identification information 39 and execution work item, and combination data of identification information 39 and symbol information, and these two types of data may be combined as terminal data. The terminal data may thus include multiple sets of combination data, and it should be possible to determine the symbol information and execution work item associated with the identification information 39 by examining the entire terminal data.

In the terminal data, it is preferable that the identification information 39 associated includes identification information 39 related to the user authenticated by the authentication application 36c. By including the identification information related to the authenticated user in the identification information 39 associated in the terminal data, it becomes possible to later confirm that the terminal data was generated by work performed by the authenticated user.

Furthermore, when the work selection application 36a accepts the registration of shipper information in step S12, the terminal data generation unit 35 of the control unit 15 may further associate the registered shipper information with the terminal data. By including the shipper information in the terminal data, it becomes possible to later confirm which work was performed for which shipper based on the terminal data.

In addition, the terminal data generation unit 35 of the control unit 15 may further associate time information (timestamp) when the symbol information was read by the reading unit 31 with the terminal data, using the time information generated by the timing unit 17. By including the timestamp in the terminal data, it becomes possible to later confirm when and what kind of work was performed based on the terminal data. Alternatively, the information processing device 40 may associate time information by adding it to the terminal data when receiving the terminal data.

Furthermore, the terminal data generation unit 35 of the control unit 15 may generate terminal data that further associates step count data calculated by the step count calculation unit 32 with the execution work item and identification information. By including the step count data in the terminal data, it becomes possible to later confirm which user performed what kind of work in which execution work item, in association with the user's movement amount.

The generated terminal data is temporarily accumulated in the temporary storage area of the memory unit 18. Once the terminal data is generated, the individual work application 36b proceeds to step S17 and determines whether the transmission condition for sending the terminal data to the information processing device 40 has been established. The transmission condition is a predetermined condition as a timing for transmitting terminal data to the information processing device 40. The transmission condition can be variously changed by the administrator of the data aggregation system 100 or the user. For example, if a condition is used where terminal data is transmitted at fixed intervals such as every 15 minutes, the transmission condition is established every 15 minutes.

Also, for example, a transmission key for specifying the timing to transmit terminal data may be included in the input unit 13, and the transmission condition may be established when the user operates the transmission key. In addition, the transmission condition may be established at various timings such as when a predetermined number of symbol information is read, when specific symbol information is read, or when switching the execution work item. Furthermore, the terminal data may be transmitted sequentially without accumulation every time symbol information is read.

If the transmission condition is not established (NO in step S17), the individual work application 36b temporarily accumulates the terminal data and returns to step S13 to wait for the trigger condition to be established for reading the next symbol information. The terminal data accumulated here is maintained until transmission is performed.

When the transmission condition is established (YES in step S17), the individual work application 36b proceeds to step S18 and transmits the accumulated terminal data collectively to the information processing device 40 via the communication unit 19.

After transmitting the terminal data, the individual work application 36b returns to step S13 and waits for the trigger condition to be established for reading the next symbol information. After the terminal data is transmitted, the terminal data accumulated in the temporary storage area may be deleted.

In this manner, the optical information reading terminal 10 repeats reading symbol information and transmitting terminal data until an event (occurrence) that marks a break in work occurs, such as when the user logs out or the execution work item is switched.

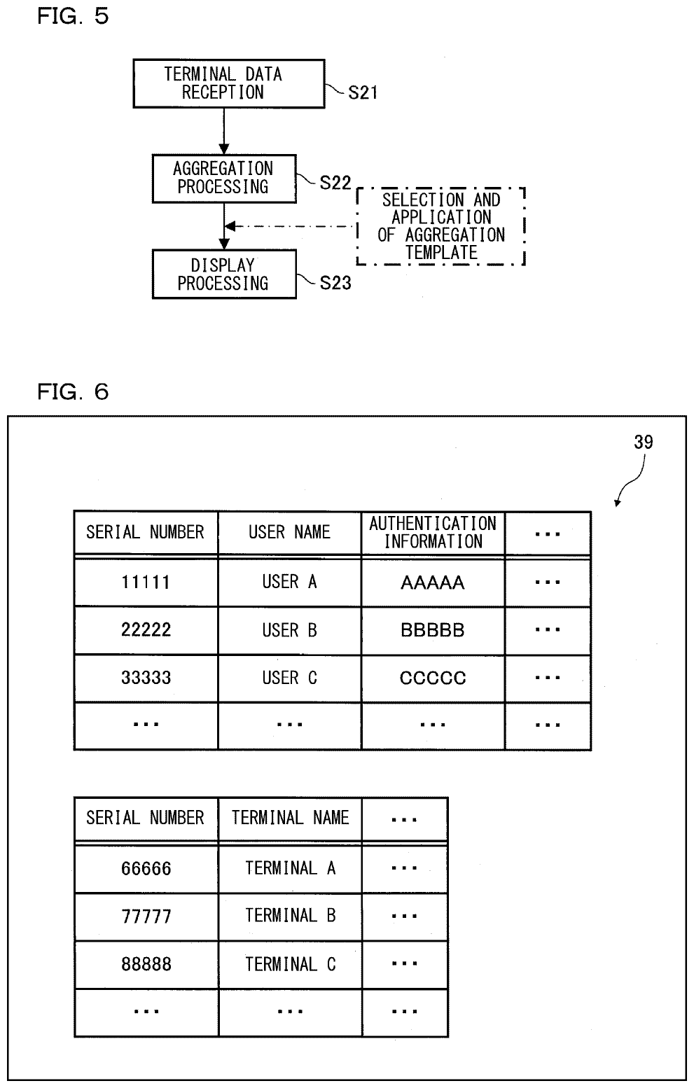

Next, referring to FIG. 5, the general flow of operations of the information processing device 40 will be explained. FIG. 5 is a flowchart showing the flow of operations of the information processing device 40. The information processing device 40 is in a standby state while there is no communication from the optical information reading terminal 10. When terminal data is transmitted from the optical information reading terminal 10, the information processing device 40 receives the transmitted terminal data through the second communication unit 45 in step S21.

The information processing device 40 that has received the terminal data proceeds to step S22, where it generates aggregation results related to the work performed by the user based on the received terminal data using the aggregation processing unit 46. Here, if multiple aggregation templates 50 are stored in the second storage unit 48, options for the aggregation templates 50 are displayed on the display device 42 for the user operating the information processing device 40 (such as the administrator of the data aggregation system 100). The user operating the information processing device 40 selects one of the displayed templates as the aggregation template 50 they wish to apply. The aggregation template 50 specifies the display format for displaying the aggregation results on the display device 42 based on the aggregation criteria associated with the aggregation template 50.

After the aggregation result is generated as described above (and in some cases, after the aggregation template 50 is further selected and applied), the display processing unit 47 causes the generated aggregation result to be displayed on the display device 42. When the aggregation template 50 is selected, the second control unit 44 causes the aggregation result generated by the aggregation processing unit 46 based on the terminal data to be displayed on the display device 42 according to the specification of the template selected from the aggregation template 50.

Next, referring to FIG. 6, specific examples of identification information 39 for identifying the optical information reading terminal 10 or the user will be explained. FIG. 6 is a diagram showing an example of the identification information 39. Among the identification information 39 shown in FIG. 6, the one shown in the upper part is user identification information 39b for identifying the user, and the one shown in the lower part is terminal identification information 39a for identifying the optical information reading terminal 10. Depending on the situation, both of these pieces of information may be used as identification information 39, or only one of them may be used.

The user identification information 39b for identifying users should include a serial number individually assigned to each user, a user name representing the user's name, and authentication information used for user login. The user name is merely information for distinguishing each user in the data aggregation system 100 and does not necessarily have to be the user's real name. The authentication information is, for example, a password stored in association with the user name. If biometric authentication is performed for login, biometric information should be stored as authentication information.

If physical key authentication is performed, authentication information stored in the physical key should be stored.

The terminal identification information 39a for identifying the optical information reading terminal 10 preferably includes a serial number individually assigned to each optical information reading terminal 10 and a terminal name representing the name of the terminal.

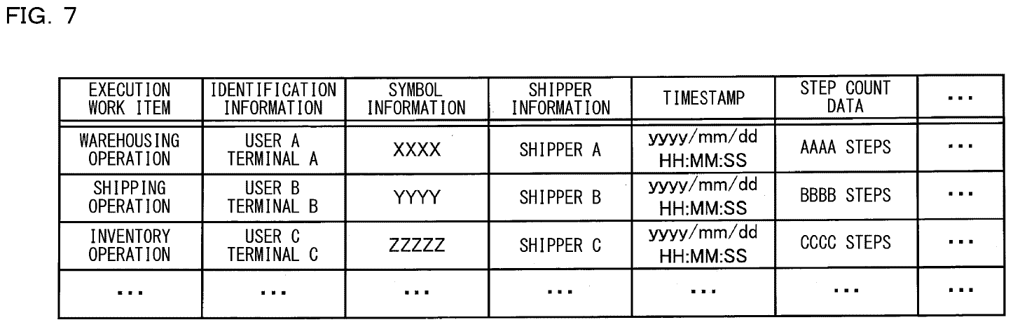

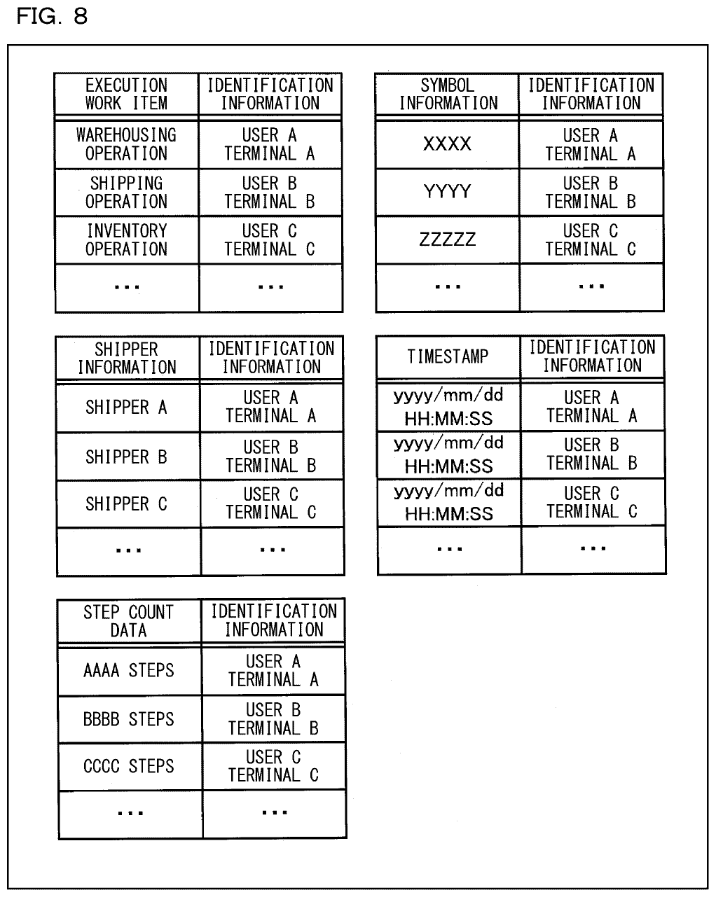

Next, referring to FIG. 7 and FIG. 8, specific examples of terminal data generated by the terminal data generation unit 35 will be explained. FIG. 7 is a diagram showing an example of terminal data. FIG. 8 is a diagram showing another example of terminal data. As shown in FIG. 7, the terminal data may be combination data in which symbol information read by the reading unit 31, execution work item selected through the work selection application 36a, and identification information related to the optical information reading terminal 10 itself are combined as a single unit of data. Here, as identification information 39, both information for identifying the user (user name) and information for identifying the optical information reading terminal 10 (terminal name) are used, but only one of these may be used as identification information 39.

As shown in FIG. 7, in the terminal data, it is preferable that information such as shipper information, timestamp (time information), and walking data are further associated with the execution work item and identification information. The shipper information should represent the information of the shipper selected by the user using the work selection application 36a when selecting the execution work item. The timestamp preferably represents the current time at the point when the symbol information was read. The timestamp (time information) should include information on date (dd), year (yyyy), month (mm), time (hour: HH, minute: MM, second: SS), and day of the week. Such information included in the timestamp may be generated by the timing unit 17, or may be calculated by the terminal data generation unit 35 based on the elapsed time from a specific reference time (for example, the reference time of UNIX® time) measured by the timing unit 17. The step count data preferably represents the cumulative step count from the time the user selected the execution work item until the time the symbol information was read.

Individual data sets (records) included in the terminal data are added each time a trigger condition is established and symbol information is read. Then, until the transmission condition is established and the terminal data is sent to the information processing device 40, records are added (accumulated) to the terminal data each time symbol information is read. When the transmission condition is established, the records accumulated up to that point are collectively transmitted to the information processing device 40 as terminal data.

While in FIG. 7 all data items are in a single unit of combination data (table), the terminal data may be an aggregate of multiple sets of combination data, as shown in FIG. 8, for example. In FIG. 8, the terminal data consists of an aggregate of multiple tables, each individually associated with identification information, for execution work items, symbol information, shipper information, timestamps, and step count data. In yet another example, the terminal data may consist of an aggregate of multiple tables, each individually associated with identification information and timestamps, for execution work items, symbol information, shipper information, and step count data. Even if the terminal data is in such a form, it is possible to obtain combination data as shown in FIG. 7 by combining each data set.

According to the optical information reading terminal 10 and the data aggregation system 100 of this embodiment, in the terminal data output from the optical information reading terminal 10, the symbol information read by the optical information reading terminal 10 and the execution work item representing the type of work performed using the optical information reading terminal 10 are associated with the identification information of the optical information reading terminal 10 or the identification information of the user who used the optical information reading terminal 10. In other words, at the time when the terminal data is output from the optical information reading terminal 10, information about the work performed using the optical information reading terminal 10 is included in the terminal data, and the association between each information item is made within the terminal data. Therefore, it becomes easier for the external information processing device 40 to investigate information about the work performed using the optical information reading terminal 10 based on the output terminal data.

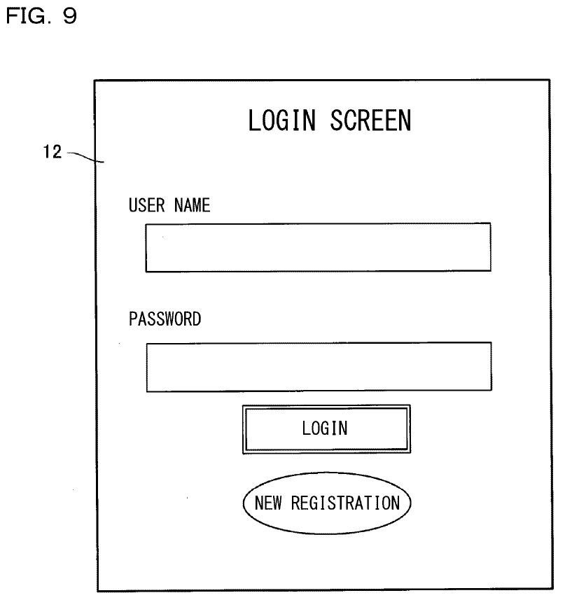

Next, referring to FIG. 9, a specific example of the login screen displayed on the display unit 12 at the startup of the optical information reading terminal 10 (Step S11 in FIG. 4) will be explained. FIG. 9 is a diagram showing an example of the login screen.

FIG. 9 shows a login screen with password authentication. While this screen is displayed, that is, while the user is not authenticated as a registered user, it is not possible to transition the display of the display unit 12 from the login screen. In other words, the optical information reading terminal 10 is in a usage restriction state.

A user whose authentication information is registered in the data aggregation system 100 enters the registered user name in the user name field, enters the password corresponding to the user name in the password field, and then presses the login button. If the combination of the entered user name and password matches the registered authentication information, the usage restriction of the optical information reading terminal 10 is released, and the user is treated as being in a logged-in state.

A user who has not yet registered authentication information in the data aggregation system 100 can operate the new registration button displayed on the login screen and input a combination of a new user name and password that they wish to register. This allows new authentication information to be registered, enabling login. However, if it is impossible to register a new user from the optical information reading terminal 10 due to security reasons or other circumstances, it is preferable that the new registration button is not displayed.

In addition, when biometric authentication or physical key authentication is performed, guidance prompting the presentation of biometric information or a physical key is displayed on the login screen. For example, it is preferable to display guidance prompting the user to have their fingerprint read by the fingerprint reader, or guidance prompting the insertion of a physical key (such as an NFC card) into the card reader.

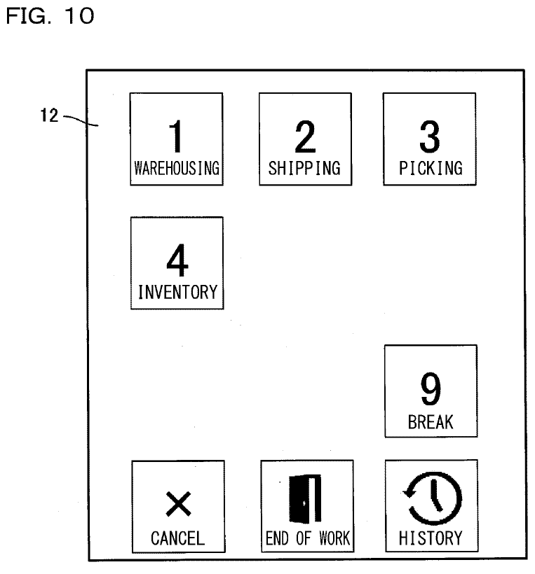

Next, referring to FIG. 10, a specific example of the screen of the work selection application 36a displayed on the display unit 12 of the optical information reading terminal 10 will be explained. FIG. 10 is a diagram showing an example of the screen of the work selection application 36a.

As shown in FIG. 10, the screen of the work selection application 36a displays buttons for multiple work item options that are candidates for execution work items, along with their work names (here, “warehousing”, “shipping”, “picking”, “inventory”) and numbers. The user selects the execution work item by choosing the button for the option that represents the work they will perform. If the display unit 12 is a touch panel, the user can select the execution work item by touching the option button. If the display unit 12 and input unit 13 are not a touch panel (not integrated), the execution work item can be selected by operating the direction keys of the input unit 13 to align the cursor with the desired option button and then operating the decision key. The execution work item may also be selected by operating the numeric key corresponding to the number displayed on the option button.

In addition to the options for work items, the screen in FIG. 10 also shows buttons for “Break”, “Cancel”, “End of Work”, and “History”. Users who wish to take a break can do so by selecting “Break” on this screen. If this screen is called up by mistake, selecting “Cancel” will return the screen displayed on the display unit 12 to its previous state. When “End of Work” is selected, the user's work for that time period ends, and aggregation processing is performed based on the terminal data up to that point. When “History” is selected, the reading history of symbol information performed using the optical information reading terminal 10 is displayed.

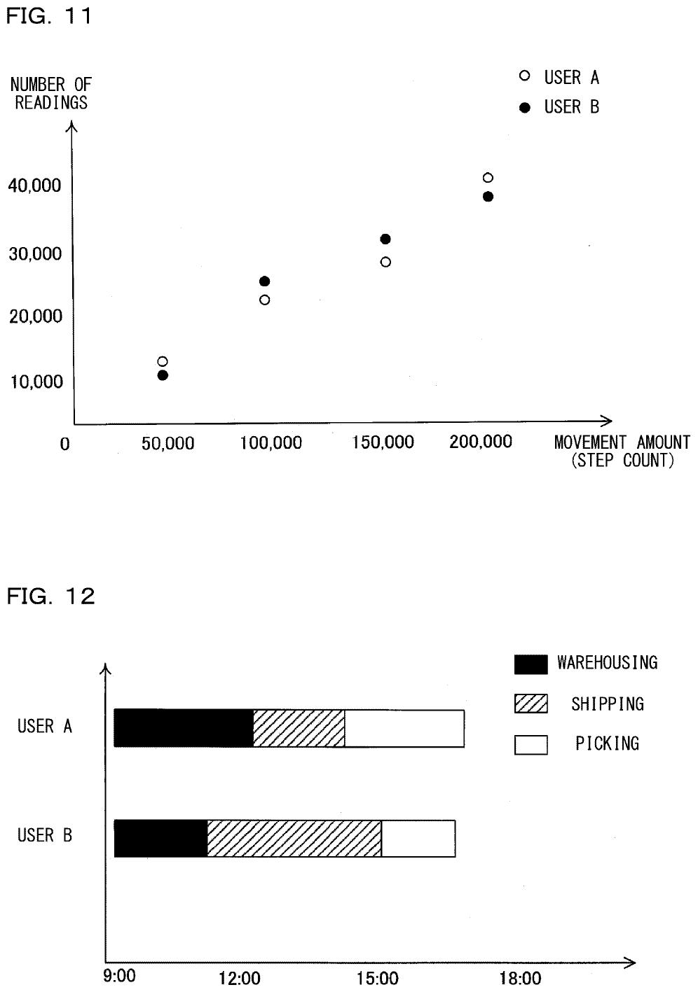

Next, referring to FIG. 11 and FIG. 12, specific examples of the display screen of aggregation results displayed on the display device 42 will be explained. FIG. 11 is a figure showing an example of the display screen of aggregation results. FIG. 12 is a figure showing another example of the display screen of aggregation results.

In FIG. 11, a graph is displayed comparing how many times users A and B read symbol 20 at each step count data point, with the horizontal axis representing the movement amount (number of steps) and the vertical axis representing the number of readings. The format of such aggregation result display screens can be changed using multiple aggregation templates 50 in the information processing device 40. Additionally, the aggregation criteria, such as the items for the vertical and horizontal axes of the graph and the items for comparison, can be changed using multiple aggregation templates 50. The items for the vertical and horizontal axes of the graph and the items for comparison can be selected from, for example, movement amount (number of steps), number of readings (workload), symbol information, execution work item, user information, terminal information, shipper information, working hours, date, year, month, time, and day of the week.

In FIG. 12, a horizontal bar graph is displayed comparing how much time User A and User B spent on “warehousing”, “shipping”, and “picking” operations during a day. By switching the aggregation template 50, even when handling the same terminal data, the display screen of the aggregation results can be made in completely different display formats, as shown in FIG. 11 and FIG. 12.

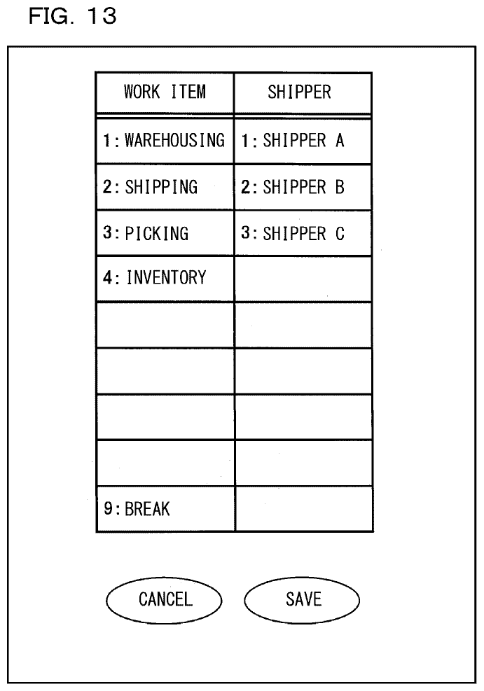

Next, referring to FIG. 13, a specific example of the application creation screen will be explained. FIG. 13 is a diagram showing an example of the application creation screen. When the information processing device 40 (FIG. 3) includes the application creation unit 48a, the information processing device 40 can display the application creation screen on the display device 42 by executing the program data of the application creation unit 48a.

As shown in FIG. 13, in the application creation screen, it is possible to edit the items displayed on the screen of the work selection application 36a. In FIG. 13, nine fields are prepared as “work items”, and specific work item names are entered in four of them. And “break” is entered as the ninth work item. When the “save” button is pressed with settings like this, the work selection application 36a will display a screen as shown in FIG. 10, which includes four options for work items and an option for a break. These work item names can be arbitrarily changed, deleted, or added on the application creation screen.

In addition, it is possible to edit shipper information on the application creation screen. In FIG. 13, information for “Shipper A”, “Shipper B”, and “Shipper C” has been input. When shipper information is input on the application creation screen in this way, after the user selects the execution work item on the screen of the work selection application 36a, options for shipper information are displayed on the display unit 12 of the optical information reading terminal 10, and the user can select for which shipper to perform the selected execution work item (for example, warehousing operation). The names of work items and shipper information set on the application creation screen are used as information to be associated in the terminal data when the user selects them on the screen of the work selection application 36a.

By the way, the embodiments are exemplary in all aspects and not restrictive. The scope of this disclosure is indicated not by the foregoing description but by the claims, and all modifications within the meaning and scope equivalent to the claims are intended to be included. Among the configurations described in the embodiments, those other than the configurations described as one aspect of this disclosure in the “means for solving the problem” are optional configurations and can be deleted or modified as appropriate.

This disclosure provides an optical information reading terminal and a data aggregation system, and has industrial applicability.

What is claimed is:

1. An optical information reading terminal for capturing a symbol to be read and reading symbol information represented by the symbol, comprising:
an imaging unit that captures the symbol and generates an input image;
a reading unit that reads the symbol information based on the input image;
a storage unit that stores a work selection application for selecting an execution work item to be executed by a user who performs work using the symbol information read by the reading unit from among multiple work items, and identification information for identifying the optical information reading terminal or the user using the optical information reading terminal;
a display unit that displays display information including a screen of the work selection application for selecting the execution work item;
a communication unit that communicates with an external information processing device;
a control unit that transmits, via the communication unit to the information processing device, terminal data in which the symbol information read by the reading unit and the execution work item selected through the work selection application are associated with the identification information related to the optical information reading terminal.

2. The optical information reading terminal according to claim 1, wherein the storage unit further stores an authentication application for restricting a use of the optical information reading terminal to a specific user, and
the control unit releases a usage restriction of the optical information reading terminal for the specific user authenticated by the authentication application, and further includes the identification information related to the specific user authenticated in the terminal data.

3. The optical information reading terminal according to claim 1, wherein the work selection application further accepts registration of shipper information related to the execution work item along with the selection of the execution work item, and the control unit transmits the terminal data to the information processing device with the shipper information registered further associated.

4. The optical information reading terminal according to claim 1, further comprising: a timing unit that generates time information, wherein the control unit transmits the terminal data to the information processing device with the time information associated with the reading of the symbol information by the reading unit.

5. The optical information reading terminal according to claim 1, further comprising: a step count calculation unit that calculates step count data related to the movement of the user, wherein the control unit transmits the terminal data to the information processing device with the step count data further associated with the execution work item and the identification information.

6. A data aggregation system comprising:
one or more optical information reading terminals according to claim 1; and
an information processing device that communicates with the one or more optical information reading terminals,
wherein the information processing device includes:
a second communication unit that receives the terminal data from the one or more optical information reading terminals,
an aggregation processing unit that generates a aggregation result related to the work performed by the user based on the terminal data, and
a display processing unit that causes a display device to display the aggregation result.

7. The data aggregation system according to claim 6, wherein
the information processing device further comprises a second storage unit that stores multiple aggregation templates,
each of the multiple aggregation templates is associated with a predetermined aggregation criterion, and the aggregation template specifies a display format for displaying the aggregation result on the display device based on the predetermined aggregation criterion, and
the aggregation result generated by the aggregation processing unit based on the terminal data is displayed on the display device according to the display format specified by an aggregation template selected from the multiple aggregation templates.

8. The information processing device according to claim 6, further comprising an application creation unit, wherein
the application creation unit generates the work selection application by accepting input of information related to multiple work items,
the information processing device transmits the work selection application generated by the application creation unit to the one or more optical information reading terminals via the second communication unit, and
the aggregation processing unit generates the aggregation result using at least one of the execution work item selected by the work selection application, the symbol information read by the reading unit, the number of readings by the reading unit, and the identification information related to the one or more optical information reading terminals as the predetermined aggregation criterion.
